(19) United States
(12) Patent Application Publication
(10) Pub. No.: US 2014/0234470 A1
(43) Pub. Date: Aug. 21, 2014

(54) Adjustable Patty Maker

(71) Applicant: Tylor Christian ROSS, Edwardsburg, MI (US)

(72) Inventor: Tylor Christian ROSS, Edwardsburg, MI (US)

(21) Appl. No.: 14/187,003

(22) Filed: Feb. 21, 2014

Related U.S. Application Data
(60) Provisional application No. 61/767,438, filed on Feb. 21, 2013.

(51) Int. Cl. A23P 1/10; A22C 7/00

(52) U.S. Cl. CPC A23P 1/105; A22C 7/0076
USPC 425/412

(57) ABSTRACT

An adjustable patty maker includes a container top, a main platform, a separator plate and a container. The container top is hingedly connected with the main platform, and the container is removably attached with the main platform opposite from the container top. The separator plate is positioned on a release paddle of the main platform so that a patty can be produced from a portion of materials. The container top moves in between an opened and closed configuration so that the portion of material can be placed on the separator plate. Once the patty is produced in between the container top and the main platform, the release paddle is able to drop the patty and the separator plate into the container.

The current application claims a priority to the U.S. Provisional Patent application Ser. No. 61/767,438 filed on Feb. 21, 2013.

### FIELD OF THE INVENTION

The present invention relates generally to an apparatus for a patty maker. More specifically, the present invention is an apparatus that efficiently make patties of different sizes out of a plurality of materials.

### BACKGROUND OF THE INVENTION

Chefs and other cooks frequently have a need to make patties out of many kinds of meats or other foods, including but not limited to ground meat, seafood, poultry, and vegetables. These patties often need to be made into different sizes for different food applications. Since the process of making patty by hands is time consuming, different type patty making machines and molds are available within food industry. Even though the conventional patty making machines provide a faster method of making patties, the conventional patty making machines often fail to provide an adjustable patty making method within one apparatus so that the users can easily make different size patties. The conventional patty making machines also fail to provide a storage system for the patties. Generally, the patties made through the conventional patty making machines have to be manually stored within a storage container by the users.

It is therefore an object of the present invention to provide a patty making machine that can efficiently and easily create patties into several different size patties out of many different types of materials while providing an easy storage system for the patties that are made through the present invention. Since the present invention provides combination of a patty making apparatus and a storage system into a single apparatus, the users of the present invention can obtain an efficient method of producing and storing patties.

### BRIEF DESCRIPTION OF THE DRAWINGS

FIG. 1 is a perspective view of the present invention in closed position, wherein the release paddle is at the retracted position.

FIG. 2 is a side view of the present invention in closed position, wherein the release paddle is at the retracted position.

FIG. 3 is a perspective view of the present invention in opened position, wherein the release paddle is at the retracted position without the separator plate.

FIG. 4 is a perspective view of the present invention in opened position, wherein the release paddle is at the extended position without the separator plate.

FIG. 5 is a perspective view of the present invention in opened position, wherein the release paddle is at the retracted position with the separator plate.

FIG. 6 is a perspective view of the container of the present invention.

FIG. 7 is a side view of the container of the present invention.

FIG. 8 is a perspective view of the main platform of the present invention.

FIG. 9 is a side view of the main platform of the present invention, showing the plane upon which a cross sectional view is taken shown in FIG. 10.

FIG. 10 is a cross section view the main platform of the present invention taken along line A-A of FIG. 9.

FIG. 11 is a perspective view of the container top of the present invention.

FIG. 12 is a side view of the container top of the present invention, showing the plane upon which a cross sectional view is taken shown in FIG. 13.

FIG. 13 is a cross section view the container top of the present invention taken along line A-A of FIG. 12.

FIG. 14 is an exploded perspective view of the present invention.

FIG. 15 is an exploded side view of the present invention.

### DETAIL DESCRIPTIONS OF THE INVENTION

All illustrations of the drawings are for the purpose of describing selected versions of the present invention and are not intended to limit the scope of the present invention.

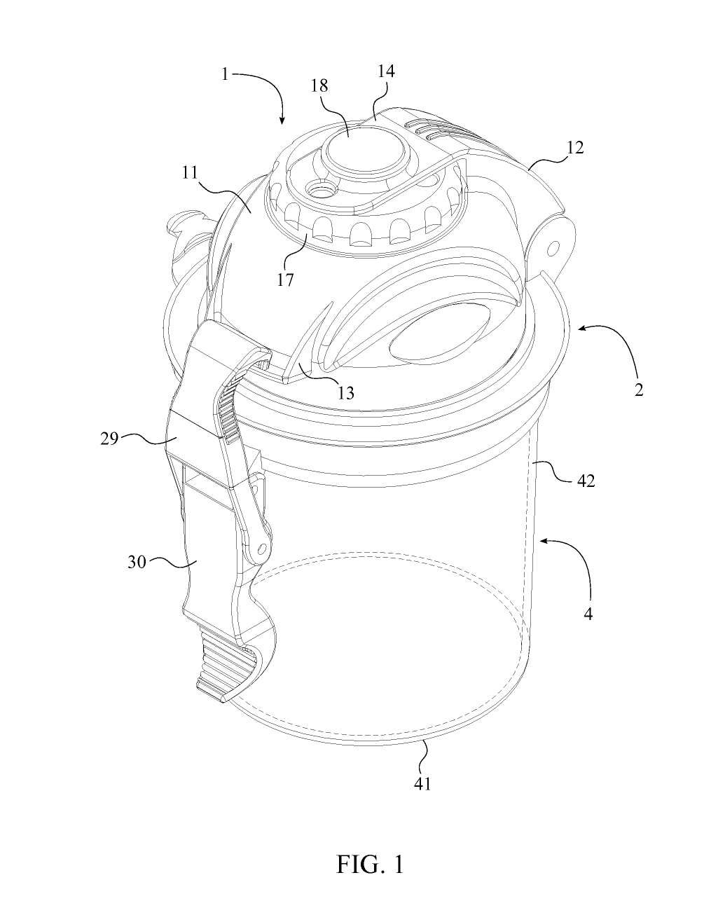

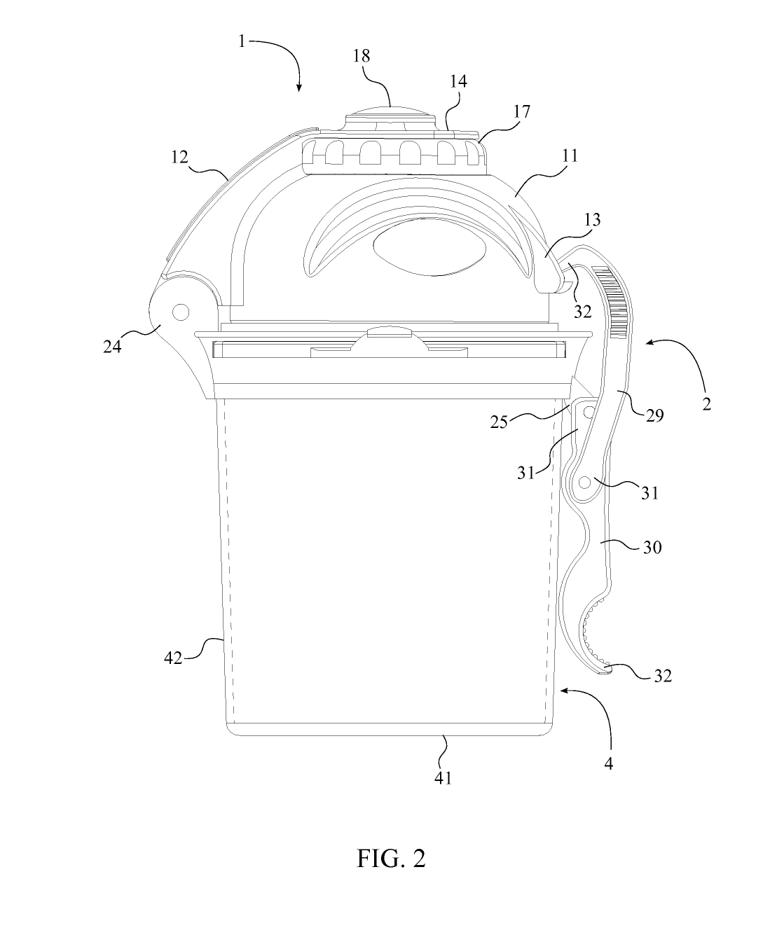

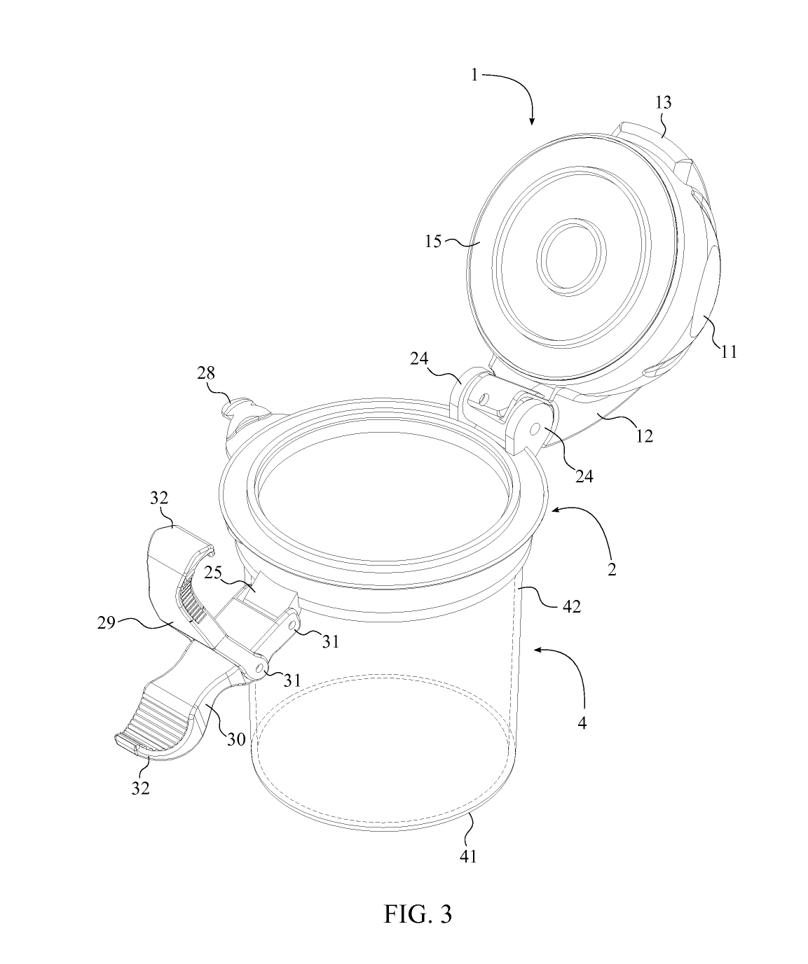

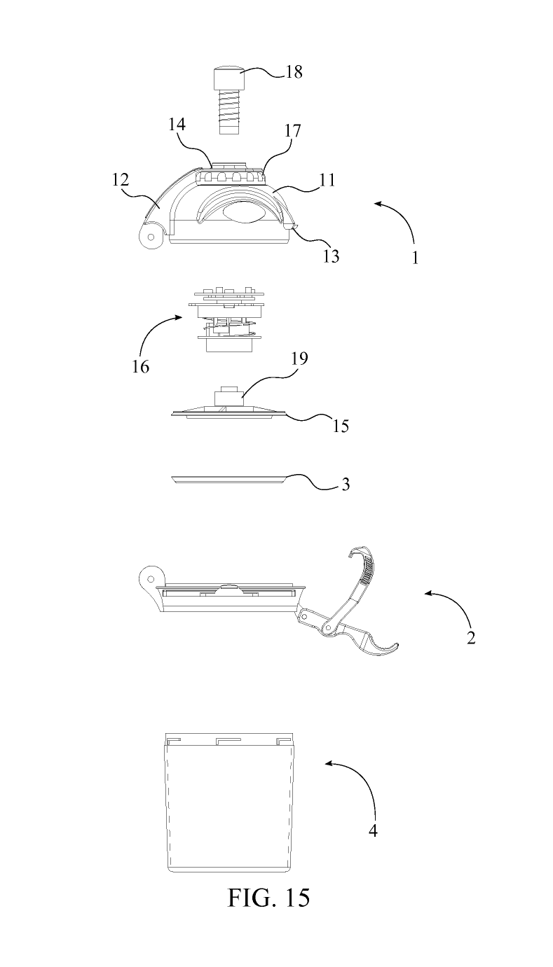

The present invention is an adjustable patty maker which enables the users to make different size patties for different type of food preparations. In reference to FIG. 1, FIG. 2, FIG. 3, FIG. 14, and FIG. 15, the present invention comprises a container top 1, a main platform 2, a separator plate 3, and a container 4. The container top 1 is hingedly connected with the main platform 2 for the reciprocating movement of the container top 1, where the container top 1 moves in between an opened configuration and a closed configuration as the container 4 is removably attached with the main platform 2 opposite of the container top 1. The configuration of the container 4, the main platform 2, and the container top 1 provide the overall form of the present invention so that the present invention can be used to make patties. In order to make a patty, the users of the present invention need to place a portion of materials onto the separator plate 3 when the container top 1 is at the opened configuration. The separator plate 3 is able to receive the portion of materials since the separator plate 3 is positioned on the main platform 2. Then the container top 1 is moved to the closed configuration, compressing the portion of materials so that the patty can be made within the present invention. After the patty is made within the main platform 2 and the container top 1, the present invention allows the users to store the patty within the container 4.

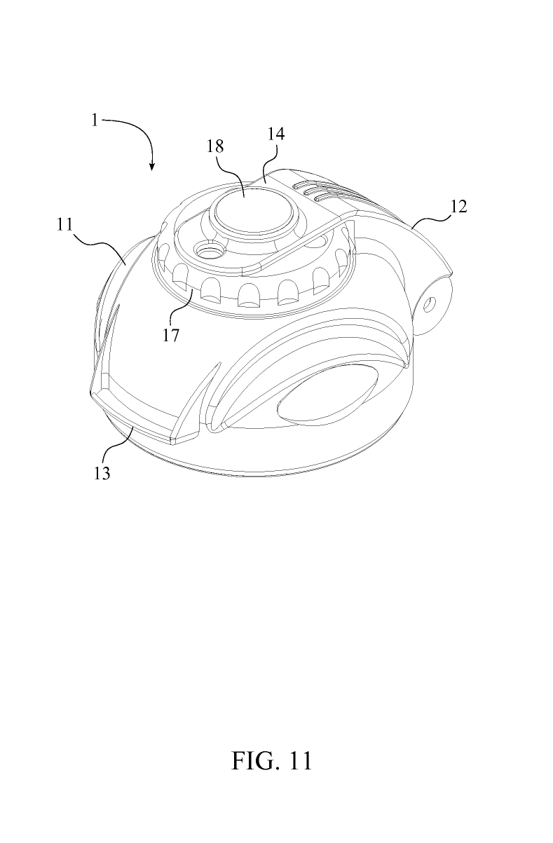

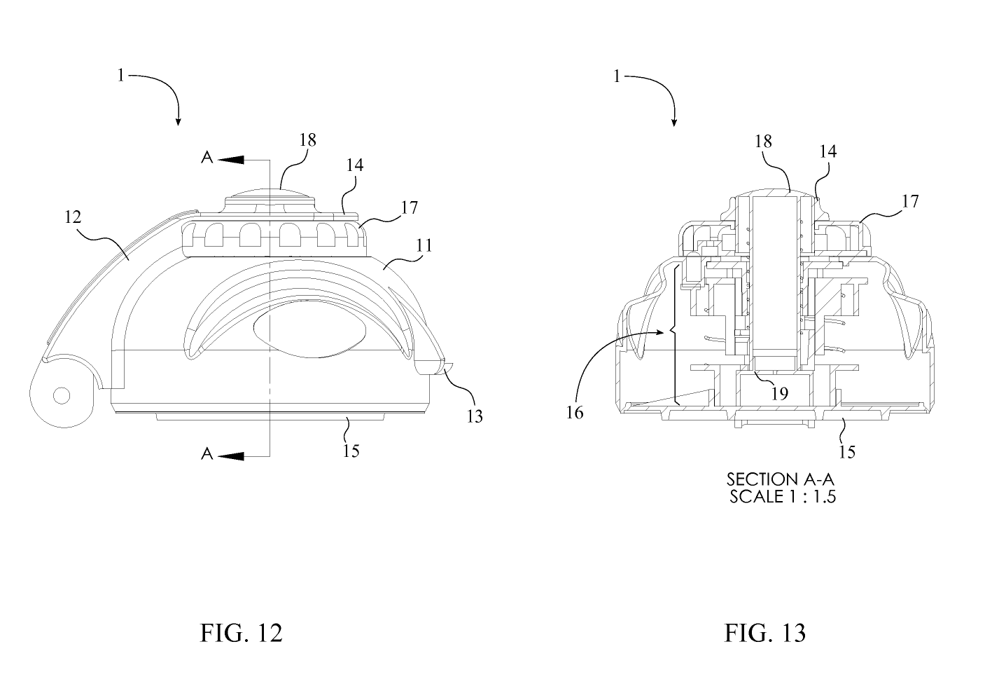

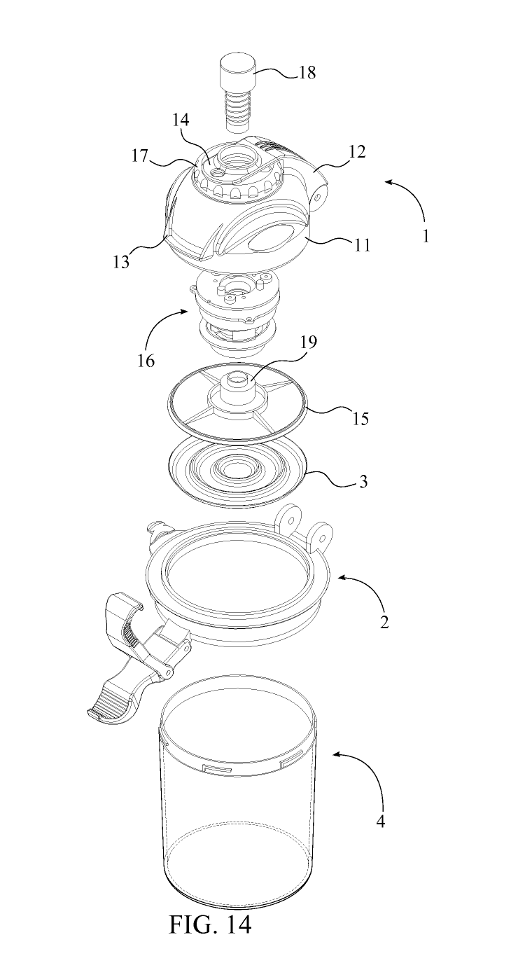

In reference to FIG. 11-FIG. 13, the container top 1 that compressed the portion of materials with the main platform 2 in order to make the patties comprises a casing 11, a protrusion 12, a locking support 13, a top extrusion 14, a press plate 15, an actuator assembly 16, an adjustment dial 17, a button 18, and a connecting member 19. The protrusion 12 is externally connected to the casing 11 so that the container top 1 can be hingedly connected with the main platform 2 through the protrusion 12. The locking support 13 is externally connected to the casing 11, where the locking support 13 is diametrically opposed of the protrusion 12. The locking support 13 enables the container top 1 to be secured within the closed configuration as the locking support 13 jointly functions with the main platform 2. The top extrusion 14 is adjacently connected to the protrusion 12 and positioned atop the casing 11. More specifically, the positioning of the top extrusion 14 and the casing 11 create a void in between the two components so that the adjustment dial 17 can be positioned in between the top extrusion 14 and the casing 11.

In reference to FIG. 11-FIG. 13, the adjustment dial 17, which enables the users to select different size patties so that the different size patties can be produced through the present invention, is concentrically positioned on the casing 11 and can be freely rotate by the users of the present invention. The adjustment dial 17 provides at least three different size settings within the present invention, where each of the size setting correlates with a different size patty within the present invention. For example, a first setting of the adjustment dial 17 can set the present invention to make a ¼ pound patty while a second setting and a third setting of the adjustment dial 17 can respectively set the present invention to make a ⅓ pound patty and a ½ pound patty. For additional clarification, the first setting, the second setting, and the third setting of the adjustment dial 17 can be respectively marked with small, medium, and large symbols to distinguish the different size patties. The actuator assembly 16 is internally connected to the casing 11 so that the actuator assembly 16 can be kept stationary within the casing 11. Additionally, the adjustment dial 17 is selectively engaged with the actuator assembly 16 from one end, and the press plate 15 is pressed against the actuator assembly 16 opposite from the adjustment dial 17. Since the press plate 15 is adjacently positioned with the bottom of the casing 11, the actuator assembly 16 is positioned within the casing 11 and in between the press plate 15 and the adjustment dial 17. When the adjustment dial 17 is rotated within the different settings, the tension within the actuator assembly 16 also changes with respect to the different settings of the adjustment dial 17 so that the press plate 15 can adjust according to the different settings. For example, when the adjustment dial 17 is set at the ½ pound patty setting, the actuator assembly 16 adjusts within the casing 11 so that the press plate 15 can accept the necessary portion of materials in order to produce the ½ pound patty.

In reference to FIG. 11-FIG. 13, the button 18 is connected with the connecting member 19, and the connecting member 19 is attached with the press plate 15 in such way that the button 18 and the connecting member 19 are concentrically positioned with the casing 11. More specifically, the button 18 is traversed through the top extrusion 14, the adjustment dial 17, the casing 11, the actuator assembly 16 and into the connecting member 19 so that the connecting member 19 can be selectively and removably attached with the press plate 15. The button 18 utilizes quick release mechanism between the connecting member 19 and the press plate 15 so that the press plate 15 can be removed from the container top 1 for sanitary purposes. The press plate 15 can comprise a plurality of ribs in many different patterns and designs so that the patties can be stamped with a specific pattern or a specific design for decorative and customized outer appearance. The plurality of ribs also creates a smooth separation in between the press plate 15 and the patties when the container top 1 is moved from the closed configuration to the opened configuration. The container top 1 can be made from any kind of materials that can withstand the frequent usage and constant pressure of the present invention, such as clear plastic, opaque plastic, metal, or any combination of thereof.

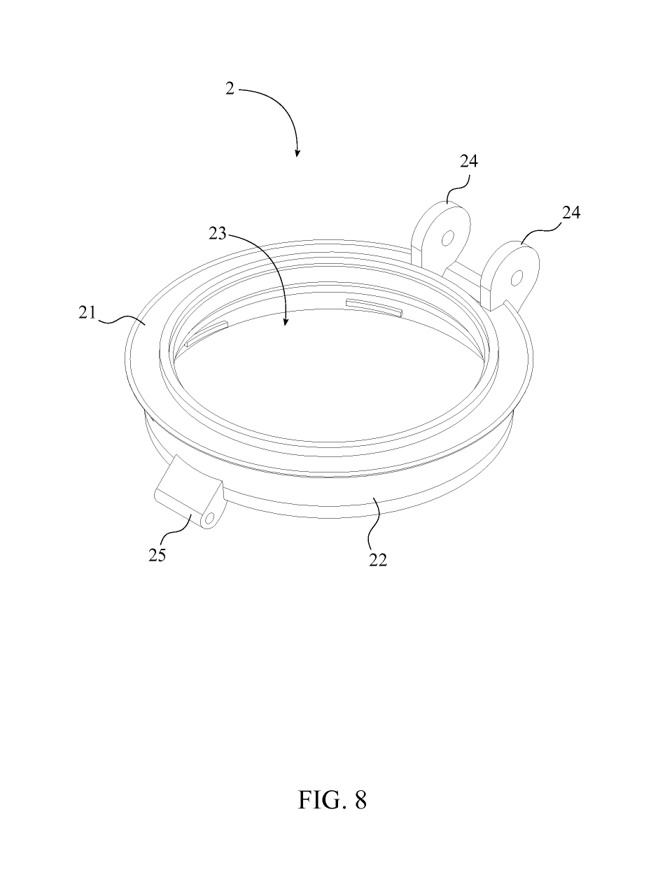

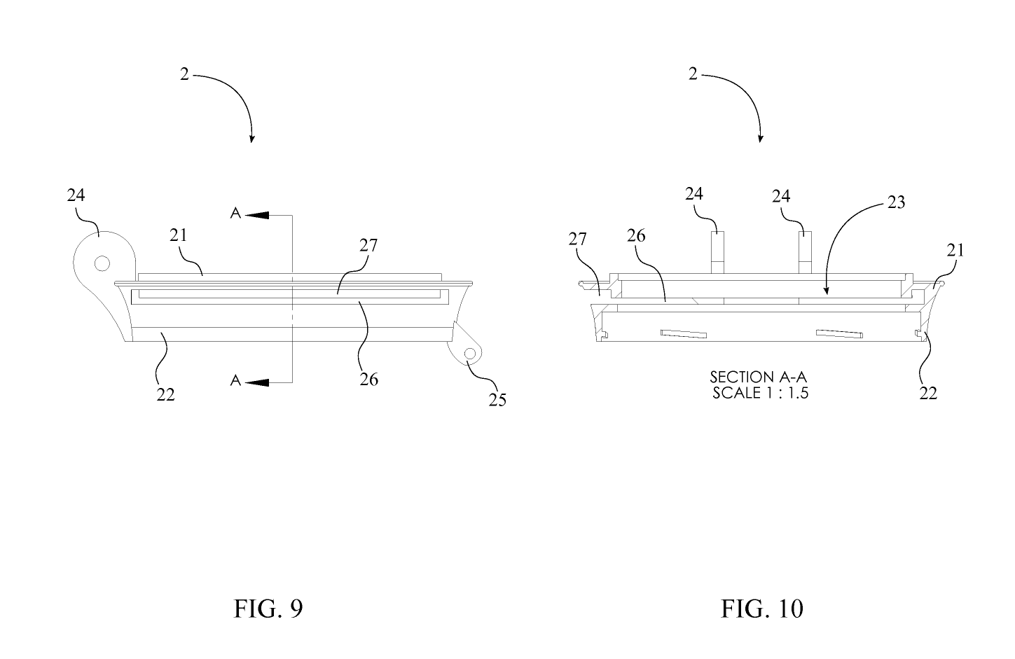

In reference to FIG. 8-FIG. 10, the main platform 2, which provides a platform for the portion of materials so that the patties can be compressed within the present invention, comprises an upper rim portion 21, a lower rim portion 22, a central cavity 23, an annular groove 26, a lateral opening 27, a release paddle 28, a pair of attachment tabs 24, a flange 25, a locking latch 29, and a locking lever 30. The upper rim portion 21 is adjacently connected on the lower rim portion 22 in such way that the upper rim portion 21 and the lower rim portion 22 are concentrically positioned with each other. As a result of the upper rim portion 21 and the lower rim portion 22, the central cavity 23 is concentrically and internally positioned with the upper rim portion 21 and the lower rim portion 22. The central cavity 23 provides a direct opening for the container 4 so that the patties can be transferred from the main platform 2 to the container 4 through the central cavity 23.

In reference to FIG. 8, the pair of attachment tabs 24 is connected to the upper rim portion 21 and oppositely positioned from the central cavity 23 and the lower rim portion 22. The pair of attachment tabs 24 is hingedly connected with the protrusion 12 so that the connection between the main platform 2 and the container top 1 can be utilized within the present invention. The flange 25 is connected to the lower rim portion 22, where the flange 25 is diametrically opposed from the pair of attachment tabs 24. More specifically, the pair of attachment tabs 24 extends outward from the upper rim portion 21 in the opposite direction from the lower rim portion 22, and the flange 25 extends outward from the lower rim portion 22 in the opposite direction from the upper rim portion 21. The flange 25 is positioned within the main platform 2 so that the flange 25 is able to accept the locking lever 30 and the locking latch 29 in such way that the locking lever 30 pivotally connects with the flange 25, and the locking latch 29 pivotally connects with the locking lever 30. More specifically, the locking lever 30 and the locking latch 29 each comprise a first end 31 and a second end 32, where the first end 31 is oppositely positioned from the second end 32 along the locking lever 30 and the locking latch 29. The first end 31 of the locking lever 30 is adjacently positioned with the flange 25 in order to permit the connection in between the locking lever 30 and the flange 25. The first end 31 of the locking latch 29 is positioned in between the first end 31 of the locking lever 30 and the second end 32 of the locking lever 30 in order to permit the connection in between the locking lever 30 and the locking latch 29. The locking latch 29 may also comprise a pair of grip strips that is oppositely positioned from each other adjacent to the second end 32 of the locking latch 29. The pair of grip strips provides secured grip surfaces for the users of the present invention so that the locking latch 29 can be efficiently handled by the users. The locking lever 30 can also comprise a friction layer, where the friction layer is adjacently positioned with the second end 32 of the locking lever 30. The friction layer provides an additional grip section within the locking lever 30 so that the locking lever 30 can be securely handled by the users. Generally, the locking lever 30 and the locking latch 29 engage with the locking support 13 in order to provide necessary compressive force into the portion of materials so that the patty can be produced within the present invention. The annular groove 26 is internally traversed into the upper rim portion 21 creating a circular indentation within the upper rim portion 21. The lateral opening 27 is externally traversed into the annular groove 26 through the upper rim portion 21 as the lateral opening 27 is extended in between the pair of attachment tabs 24 and the flange 25. The annular groove 26 and the lateral opening 27 are positioned within the main platform 2 so that the main platform 2 is able to accept the release paddle 28.

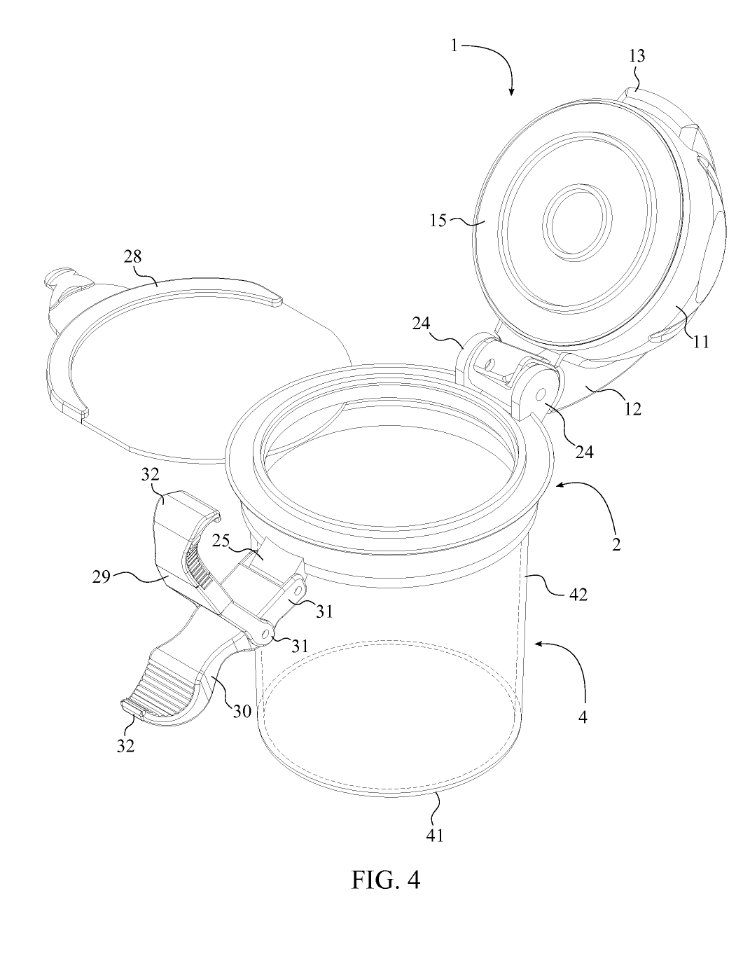

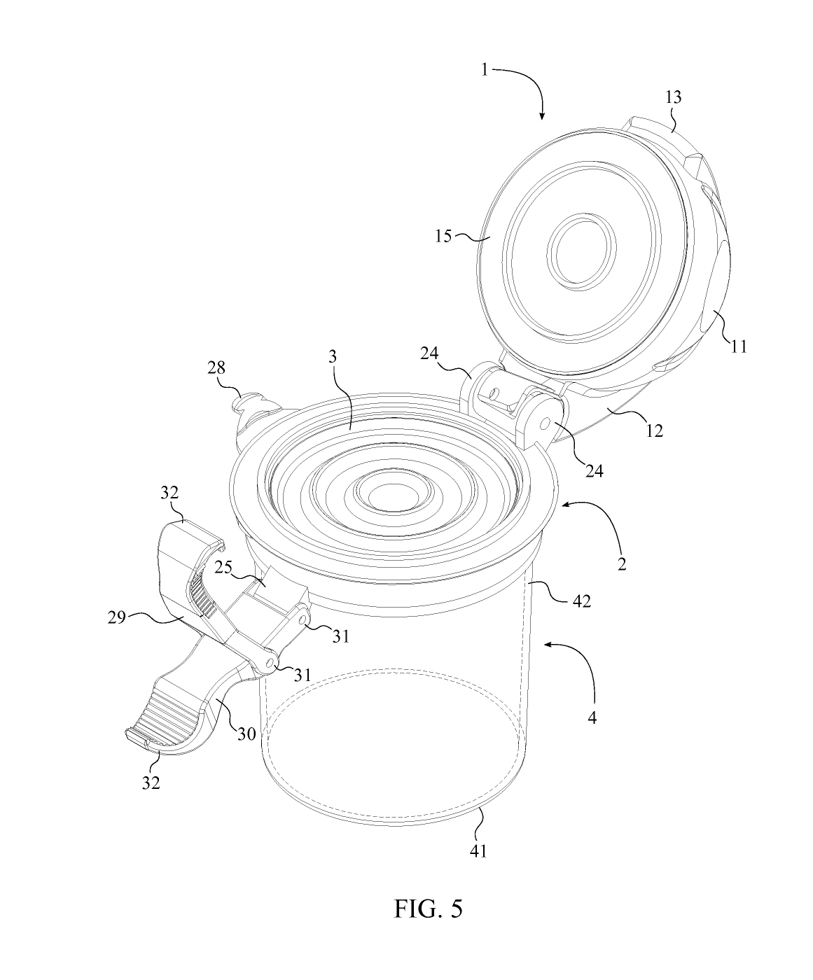

In reference to FIG. 3-FIG. 5, the release paddle 28 is used within the present invention so that the users can use the release paddle 28 as a foundation to retain the separator plate 3 in the process of making patties. Additionally, the release paddle 28 also allows the users to discharge the patties into the container 4. More specifically, the release paddle 28 is selectively positioned with the annular groove 26 and the lateral opening 27 for reciprocating movement between a retracted position and an extended position. When the release paddle 28 is concentric with the container 4, the release paddle 28 is considered to be in the retracted position. The retracted position allows the users of the present invention to place the separator plate 3 on the release paddle 28 as the separator plate 3 is concentrically positioned with the release paddle 28. Additionally, the retracted position also closes the central cavity 23, where the release paddle 28 functions as a barrier in between the main platform 2 and the container 4. When the release paddle 28 is offset with the container 4, the release paddle 28 is considered to be in the extended position. The extended position allows the users of the present invention to discharge the separator plate 3 into the container 4 as the movement of the release paddle 28 from the retracted position to the extended position opens up the central cavity 23. More specifically, when the release paddle 28 is moved from the retracted position to the extended position, only the release paddle 28 moves outwardly along the annular groove 26 and the lateral opening 27; however, the separator plate 3 is retained within the central cavity 23. Once the release paddle 28 is completely cleared underneath the separator plate 3, the separator plate 3 is able to drop into the container 4 through the central cavity 23. The main platform 2 can be made from any kind of materials that can withstand the frequent usage and constant pressure of the present invention, such as clear plastic, opaque plastic, metal, or any combination of thereof.

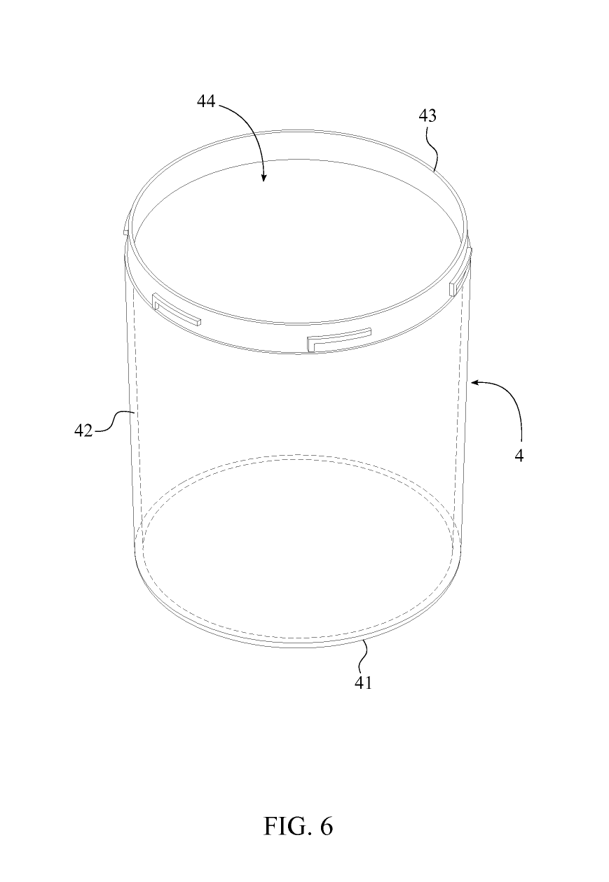

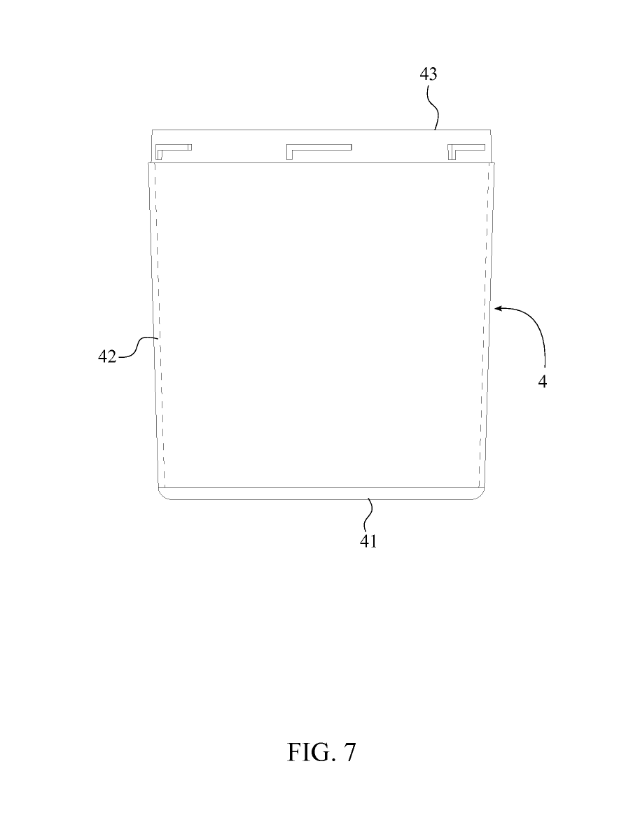

In reference to FIG. 6 and FIG. 7, the container 4 allows the users of the present invention to continuously make patties since the container 4 can store a plurality of patties. The container 4 comprises a base 41, a lateral wall 42, a brim 43, and a container opening 44. The lateral wall 42 is perimetrically positioned around the base 41, and the brim 43 is perimetrically positioned around the lateral wall 42 opposite of the base 41. When the container 4 is attached with the main platform 2, the lateral wall 42 is removably attached with the lower rim in such way that the upper rim portion 21 is positioned atop the brim 43. The present invention can utilize any kind of known attachment mechanisms, such twist attachment mechanisms, span-fit attachment mechanisms, and magnetic attachment systems, to attach the container 4 and the main platform 2. The configuration of the base 41, the lateral wall 42, and the brim 43 form the container opening 44 in such way that the container opening 44 extends from the brim 43 to the base 41 along the lateral wall 42. The container opening 44 allows the users of the present invention continuously store patties, where each of the patties is separated by the separator plate 3 so that the patties can be easily removed from one another through the container opening 44 when necessary. The container 4 can be made from any kind of materials that can withstand the frequent usage of the present invention, including, but is not limited to, clear plastic, opaque plastic, and glass.

In order to make a patty within the present invention, the users first need to open the container top 1 from the main platform 2 so that the present invention is at the opened configuration. When the present invention is at the opened configuration, the locking lever 30 and the locking latch 29 are positioned away from the locking support 13 so that the separator plate 3 and the portion of materials can be placed within on the release paddle 28 in order to make a patty. Since the container top 1 is angularly positioned with respect to the main platform 2 about the pair of attachment tabs 24 and the protrusion 12, and the release paddle 28 is at the retracted position, users can easily access the main platform 2 to place the separator plate 3 and the portion of materials. Then the separator plate 3 is placed on the release paddle 28, and the portion of material is centrally positioned on the separator plate 3. The present invention is then moved into the closed configuration, where the container top 1 is concentrically positioned with the container 4 and the main platform 2, and the locking latch 29 is engaged with the locking support 13 so that the container top 1 can be pressed against the portion of materials. More specifically, the second end 32 of the locking latch 29 is engaged with the locking support 13, and the locking lever 30 is pressed in the downward direction from the second end 32 of the locking lever 30. Since the second end 32 of the locking latch 29 is engaged with the locking support 13 and the first end 31 of the locking latch 29 is pivotally connected with the locking lever 30, the locking latch 29 pulls the container top 1 in the downward direction along with the locking lever 30. When the locking lever 30 is adjacently positioned with the lateral wall 42, the present invention considered to be in the closed position. The interlocking components of the locking lever 30, the locking latch 29, the locking support 13, and the container 4 create a locking sound within the present invention, where the locking sound indicates that the present invention is at the closed configuration. Then the users can move the locking lever 30 in the upward direction, disengaging the locking latch 29 from the locking support 13 so that the present invention can be moved back into the opened configuration. Then the release paddle 28 is moved into the extended position so that the separator plate 3 and the patty can be dropped into the container 4 through the central cavity 23 and the container opening 44. This process of making a patty can be continuously carried out through the present invention until the container 4 is filled with patties. Once the container 4 is filled with patties, the users can detach the container 4 from the main platform 2 either to attach secondary container that is similar to the container 4 or to empty the patties from the container 4.

Although the invention has been explained in relation to its preferred embodiment, it is to be understood that many other possible modifications and variations can be made without departing from the spirit and scope of the invention as hereinafter claimed.

What is claimed is:

1. An adjustable patty maker comprises:
a container top;
a main platform;
a separator plate;
a container;
the container top comprises a casing, a protrusion, a locking support, a top extrusion, a press plate, an actuator assembly, an adjustment dial, a button, and a connecting member;
the main platform comprises an upper rim portion, a lower rim portion, a central cavity, an annular groove, a lateral opening, a release paddle, a pair of attachment tabs, a flange, a locking latch, and a locking lever;
the container comprises a base, a lateral wall, a brim, and a container opening;
the container top being hingedly connected with the main platform, wherein the container top reciprocally moves in between an opened configuration and a closed configuration; and
the container being removably attached with the main platform opposite of the container top.

2. The adjustable patty maker as claimed in claim 1 comprises:
the protrusion being externally connected to the casing;
the locking support being externally connected to the casing;
the locking support being diametrically opposed of the protrusion;
the top extrusion being adjacently connected to the protrusion;
the top extrusion being positioned atop the casing;
the adjustment dial being positioned in between the top extrusion and the casing;
the actuator assembly being internally connected to the casing;
the adjustment dial being selectively engaged with the actuator assembly;
the press plate being pressed against the actuator assembly opposite from the adjustment dial;
the actuator assembly being positioned within the casing and in between the press plate and the adjustment dial;
the button traversing through the top extrusion, the adjustment dial, the casing, the actuator assembly, and into the connecting member;
the connecting member being connected with the button; and
the connecting member being selectively and removably attached with the press plate.

3. The adjustable patty maker as claimed in claim 1 comprises:
the upper rim portion being adjacently connected on the lower rim portion;
the upper rim portion being concentrically positioned with the lower rim portion;
the central cavity being concentrically and internally positioned with the upper rim portion and the lower rim portion;
the pair of attachment tabs being connected to the upper rim portion;
the pair of attachment tabs being oppositely positioned from the central cavity and the lower rim portion;
the flange being connected to the lower rim portion;
the flange being diametrically opposed from the pair of attachment tabs;
the annular groove internally traversing into the upper rim portion;
the annular groove being concentrically positioned with the upper rim portion;
the lateral opening externally traversing into to the annular groove through the upper rim portion;
the lateral opening being extended in between the pair of attachment tabs and the flange; and
the release paddle being selectively positioned with the annular groove and the lateral opening, wherein the release paddle reciprocally moves in between a retracted position and an extended position.

4. The adjustable patty maker as claimed in claim 3 comprises:
the release paddle being concentric with the container for the retracted position; and
the separator plate being concentrically positioned on the release paddle.

5. The adjustable patty maker as claimed in claim 3 comprises;
the release paddle being offset with the container for the extended position; and
the separator plate being concentrically positioned within the container opening.

6. The adjustable patty maker as claimed in claim 1 comprises:
the locking lever being pivotally connected with the flange; and
the locking latch being pivotally connected with the locking lever.

7. The adjustable patty maker as claimed in claim 6 comprises:
the locking latch and the locking lever each comprise a first end and a second end;
the first end being oppositely positioned from the second end;
the first end of the locking lever being adjacently positioned with the flange; and
the first end of the locking latch being positioned in between the first end of the locking lever and the second end of the locking lever.

8. The adjustable patty maker as claimed in claim 1 comprises:
the lateral wall being perimetrically positioned around the base;
the brim being perimetrically positioned around the lateral wall opposite of the base; and
the container opening being formed by the brim, the lateral wall, and the base.

9. The adjustable patty maker as claimed in claim 1 comprises:
the protrusion being hingedly connected with the pair of attachment tabs;
the lateral wall being removably attached with the lower rim portion; and
the upper rim portion being positioned atop the brim.

10. The adjustable patty maker as claimed in claim 1 comprises:
the opened configuration;
the container top being angularly positioned with the main platform about the pair of attachment tabs and the protrusion; and
the locking latch and the locking lever being positioned away from the locking support.

11. The adjustable patty maker as claimed in claim 1 comprises:
the closed configuration;
the container top being concentrically positioned with the main platform;
the locking latch being engaged with the locking support; and
the locking lever being adjacently positioned with the lateral wall.

12. An adjustable patty maker comprises:
a container top;
a main platform;
a separator plate;
a container;
the container top comprises a casing, a protrusion, a locking support, a top extrusion, a press plate, an actuator assembly, an adjustment dial, a button, and a connecting member;
the main platform comprises an upper rim portion, a lower rim portion, a central cavity, an annular groove, a lateral opening, a release paddle, a pair of attachment tabs, a flange, a locking latch, and a locking lever;
the container comprises a base, a lateral wall, a brim, and a container opening;
the protrusion being externally connected to the casing;
the locking support being externally connected to the casing;
the locking support being diametrically opposed of the protrusion;
the top extrusion being adjacently connected to the protrusion;
the top extrusion being positioned atop the casing;
the adjustment dial being positioned in between the top extrusion and the casing;
the actuator assembly being internally connected to the casing;
the adjustment dial being selectively engaged with the actuator assembly;
the press plate being pressed against the actuator assembly opposite from the adjustment dial;
the actuator assembly being positioned within the casing and in between the press plate and the adjustment dial;
the button traversing through the top extrusion, the adjustment dial, the casing, the actuator assembly, and into the connecting member;
the connecting member being connected with the button;
the connecting member being selectively and removably attached with the press plate;
the container top being hingedly connected with the main platform, wherein the container top reciprocally moves in between an opened configuration and a closed configuration; and
the container being removably attached with the main platform opposite of the container top.

13. The adjustable patty maker as claimed in claim 12 comprises:
the upper rim portion being adjacently connected on the lower rim portion;
the upper rim portion being concentrically positioned with the lower rim portion;
the central cavity being concentrically and internally positioned with the upper rim portion and the lower rim portion;
the pair of attachment tabs being connected to the upper rim portion;
the pair of attachment tabs being oppositely positioned from the central cavity and the lower rim portion;
the flange being connected to the lower rim portion;
the flange being diametrically opposed from the pair of attachment tabs;
the annular groove internally traversing into the upper rim portion;
the annular groove being concentrically positioned with the upper rim portion;
the lateral opening externally traversing into to the annular groove through the upper rim portion;
the lateral opening being extended in between the pair of attachment tabs and the flange;
the release paddle being selectively positioned with the annular groove and the lateral opening, wherein the release paddle reciprocally moves in between a retracted position and an extended position;
the locking lever being pivotally connected with the flange; and
the locking latch being pivotally connected with the locking lever.

14. The adjustable patty maker as claimed in claim 13 comprises:
the release paddle being concentric with the container for the retracted position; and
the separator plate being concentrically positioned on the release paddle.

15. The adjustable patty maker as claimed in claim 13 comprises;
the release paddle being offset with the container for the extended position; and
the separator plate being concentrically positioned within the container opening.

16. The adjustable patty maker as claimed in claim 13 comprises:
the locking latch and the locking lever each comprise a first end and a second end;
the first end being oppositely positioned from the second end;
the first end of the locking lever being adjacently positioned with the flange; and
the first end of the locking latch being positioned in between the first end of the locking lever and the second end of the locking lever.

17. The adjustable patty maker as claimed in claim 12 comprises:
the lateral wall being perimetrically positioned around the base;
the brim being perimetrically positioned around the lateral wall opposite of the base; and
the container opening being formed by the brim, the lateral wall, and the base.

18. The adjustable patty maker as claimed in claim 12 comprises:
the protrusion being hingedly connected with the pair of attachment tabs;
the lateral wall being removably attached with the lower rim portion; and
the upper rim portion being positioned atop the brim.

19. The adjustable patty maker as claimed in claim 12 comprises:
the opened configuration;
the container top being angularly positioned with the main platform about the pair of attachment tabs and the protrusion; and
the locking latch and the locking lever being positioned away from the locking support.

20. The adjustable patty maker as claimed in claim 12 comprises:
the closed configuration;
the container top being concentrically positioned with the main platform;
the locking latch being engaged with the locking support; and
the locking lever being adjacently positioned with the lateral wall.
